(19) United States
(12) Patent Application Publication
(10) Pub. No.: US 2023/0384843 A1
(43) Pub. Date: Nov. 30, 2023

(54) CONFIGURATION CHANGES FOR EXPANSION CARDS

(71) Applicant: HEWLETT-PACKARD DEVELOPMENT COMPANY, L.P., Spring, TX (US)

(72) Inventors: Jui Ching Chang, Taipei City (TW); Chao-Wen Cheng, Taipei City (TW); Tsung Yen Chen, Taipei City (TW); Chien-Cheng Su, Taipei City (TW)

(21) Appl. No.: 17/826,512

(22) Filed: May 27, 2022

(51) Int. Cl. G06F 1/18; G06F 9/4401; G06F 13/42

(52) U.S. Cl. CPC G06F 1/185; G06F 9/4411; G06F 13/4282; G06F 2213/0026

(57) ABSTRACT

In example implementations, a computing device is provided. The computing device includes an expansion interface, a memory, a controller, and a configuration change module. The expansion interface includes a plurality of slots to connect to a respective add-in card and a re-timer to control an operation of the plurality of slots. The memory is to store a firmware that sets a configuration of the plurality of slots, wherein the re-timer is to control the operation of the plurality of slots in accordance with the configuration set by the firmware. The controller is to control operation of the expansion interface. The configuration change module is to change the configuration of the plurality of slots when a change in a number of connected add-in cards is detected.

### BACKGROUND

Computing devices can be used to execute various applications and programs. A processor is deployed in a computing device to execute the applications and programs. The computing device can have additional components that can help execute the applications, such as memory, graphics processors, and the like.

The computing device may include expansion interfaces to allow additional components to be added to the computing device. The additional components may add functionality to the computing device. For example, the additional components may provide more powerful graphics, larger amounts of memory, additional communication interfaces, and the like.

### BRIEF DESCRIPTION OF THE DRAWINGS

FIG. 1 is a block diagram of an example computing device with a configuration change module of the present disclosure to change a configuration of a plurality of slots of an expansion interface;

FIG. 2 is a block diagram of an example configuration change module of the present disclosure;

FIG. 3 is a block diagram of another example configuration change module of the present disclosure;

FIG. 4 is a flow chart of an example method to change a configuration of a plurality of slots of an expansion interface of the present disclosure; and

FIG. 5 is an example non-transitory computer readable storage medium storing instructions executed by a processor to control power savings features of add-in cards connected to an expansion interface of the present disclosure.

### DETAILED DESCRIPTION

Examples described herein provide a computing device and method to change a configuration of an expansion interface when changes to a number of connected add-in-cards is detected. As discussed above, computing devices can be used to execute various applications and programs. A computing device may include expansion interfaces to allow additional components to be added to the computing device. The additional components may add functionality to the computing device. For example, the additional components may provide more powerful graphics, larger amounts of memory, additional communication interfaces, and the like.

An example of the additional components may include add-in cards (AICs) that can be connected to an expansion interface. The data rate for expansion interfaces (e.g., peripheral connect interconnect express (PCIe) cards) has increased over time as technology has improved. However, the expansion interface can suffer from signal distortion or degradation due to printed circuit board (PCB) material loss, impedance discontinuities in channels (e.g., vias and connectors), and the like. To compensate for these signal distortions, the expansion interface may use a repeater to get an undistorted signal.

There are two different types of repeaters that can be used: a re-driver or a re-timer. The re-driver is a protocol-unaware device that amplifies the signal. The re-timer is a protocol aware device that reconstructs the signal. In other words, the re-timer can send a fresh copy of the signal. The re-timer can provide better signal integrity than the re-driver.

As a result, some expansion interfaces may use a re-driver to ensure signal quality at higher data rates (e.g., up to 32 gigabytes per second (Gbps) for fifth generation PCIe cards). Current re-driver expansion cards have a fixed configuration based on the implemented firmware after the computing device is powered on. For example, if a single 1×16 AIC is connected to the expansion interface, the computing device cannot change to a 2×8 configuration to operate two AICs connected to the expansion interface without making a firmware change or update.

Changing the firmware for the computing device can be complicated. Some users may be afraid of making software changes to the computing device that can affect the operation of the basic input/output system (BIOS).

The present disclosure provides solutions to automatically change the configuration of the expansion interface when a change in the number of connected AICs is detected. Thus, the user may not have to update firmware to change the configuration of the expansion interface. Rather, the user may simply turn the computing device off, add or remove an AIC to the expansion interface, and then turn the computing device back on. The computing device may detect the change and automatically reconfigure the expansion interface to operate in a 1×16 configuration or a 2×8 configuration based on the detected number of connected AICs.

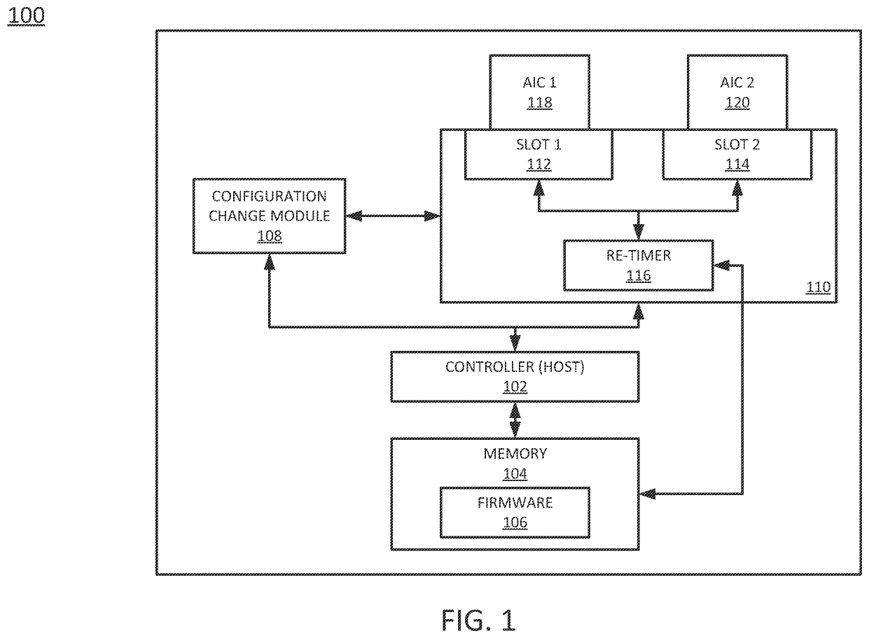

FIG. 1 illustrates an example computing device 100 that includes a configuration change module 108 of the present disclosure to change a configuration of an expansion interface 110 when a change in a number of connected add-in cards (AICs) 118 and 120 is detected. It should be noted that the computing device 100 illustrated in FIG. 1 has been simplified for ease of explanation and may include additional components that are not shown. For example, the computing device 100 may include input/output interfaces (e.g., a keyboard, a mouse, a trackpad, a display, a touchscreen, and the like), a power supply, various interfaces (e.g., a universal serial bus (USB) interface), a central processing unit (CPU), a graphics processor, and the like.

In an example, the computing device 100 may include a controller 102, a memory 104, an expansion interface 110, and the configuration change module 108. The controller 102 may be communicatively coupled to the memory 104, the configuration change module 108, and the expansion interface 110. The controller 102 may control operation of the expansion interface 110 and the configuration change module 108. The controller 102 may also execute instructions stored in the memory 104 to perform the functions described herein.

In an example, the memory 104 may be any type of non-transitory computer readable medium. For example, the memory 104 may be a random access memory (RAM), a read-only memory (ROM), a hard disk drive, a solid state drive, and the like. In an example, the memory 104 may be an electrically erasable programmable read-only memory (EEPROM) that stores a firmware 106. The firmware 106 may be an initially stored and loaded firmware 106 to establish an initial configuration of the expansion interface 110 based on the number of AICs 118 and/or 120 that are connected to the expansion interface 110.

Either or both of the AICs 118 and 120 may be any type of AIC that is compatible with the expansion interface 110, such as a graphics processor, a memory, and the like. For example, the expansion interface 110 may be a peripheral component interconnect express (PCIe) interface. The AICs 118 and 120 may be graphics cards or PCIe memories that can be connected to the expansion interface 110 via a first slot 112 or a second slot 114.

In an example, the expansion interface 110 may also include a re-timer 116. The re-timer 116 may be communicatively coupled to the first slot 112 and the second slot 114 to control operation of the first slot 112 and the second slot 114. As discussed above, the re-timer 116 may be a type of protocol aware repeater that can reconstruct data signals or send a fresh copy of a data signal across the data lanes of the expansion interface 110.

In an example, the first slot 112 may use eight data lanes as part of a 2×8 configuration when two AICs 118 and 120 are connected to the first slot 112 and the second slot 114, respectively. The second slot 114 may use 16 data lanes as part of a 1×16 configuration when the AIC 120 is connected to the second slot 114 and the first slot 112 is empty. The second slot 114 may also be configured to use 8 data lanes as part of a 2×8 configuration when two AICs 118 and 120 are connected to the first slot 112 and the second slot 114, respectively.

The firmware 106 may initially configure the first slot 112 and the second slot 114 for a 1×16 or 2×8 configuration and set the re-timer 116 to operate the first slot 112 and the second slot 114 in accordance with the initial configuration. For example, if the computing device 100 is initially deployed with two AICs 118 and 120, the firmware that is initially saved to memory 104 and loaded during power on by the computing device 100 would be a 2×8 configuration for the first slot 112 and the second slot 114. The re-timer 116 would operate the first slot 112 and the second slot 114 in the 2×8 configuration.

However, as noted above, after the initial firmware 106 is saved and loaded, the configuration of the first slot 112 and the second slot 114 and/or operation of the re-timer 116 cannot be changed without updating the firmware 106. In other words, a user would have to find the firmware for the desired configuration, save over the firmware 106 with the new firmware, and restart the computing device 100. Most users are not comfortable with updating firmware, as firmware is typically saved in system memory that can affect the operation of different hardware components of the computing device 100.

The present disclosure provides the configuration change module 108 that can change the configuration of the first slot 112 and the second slot 114 without updating the firmware 106 or downloading new firmware for the new desired configuration. Rather, when a change in the number of connected AICs 118 and 120 is detected (e.g., from two AICs to one AIC or one AIC to two AICs), the configuration change module 108 may change the configuration of the first slot 112 and the second slot 114. In addition, the re-timer 116 may be controlled to operate the first slot 112 and the second slot 114 in accordance with the configuration change implemented by the configuration change module 108.

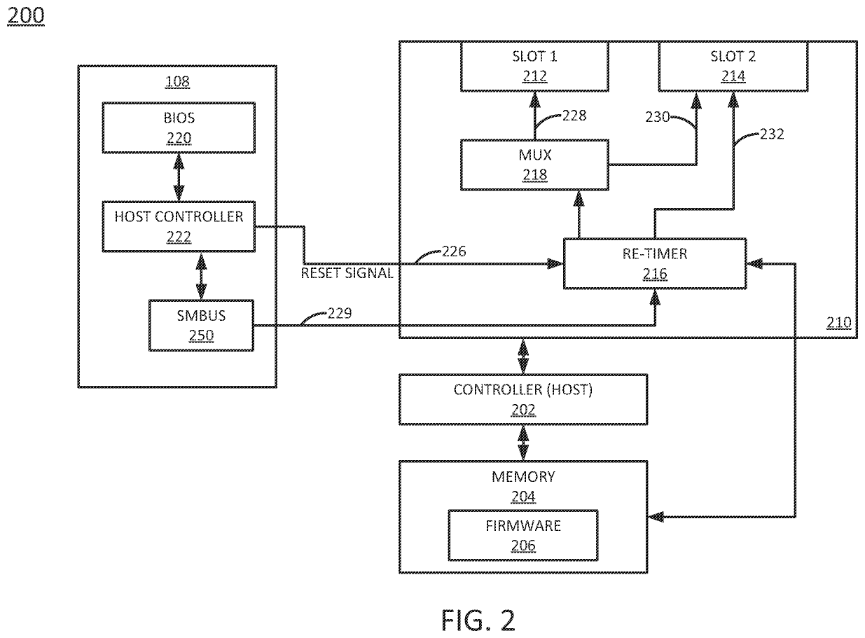

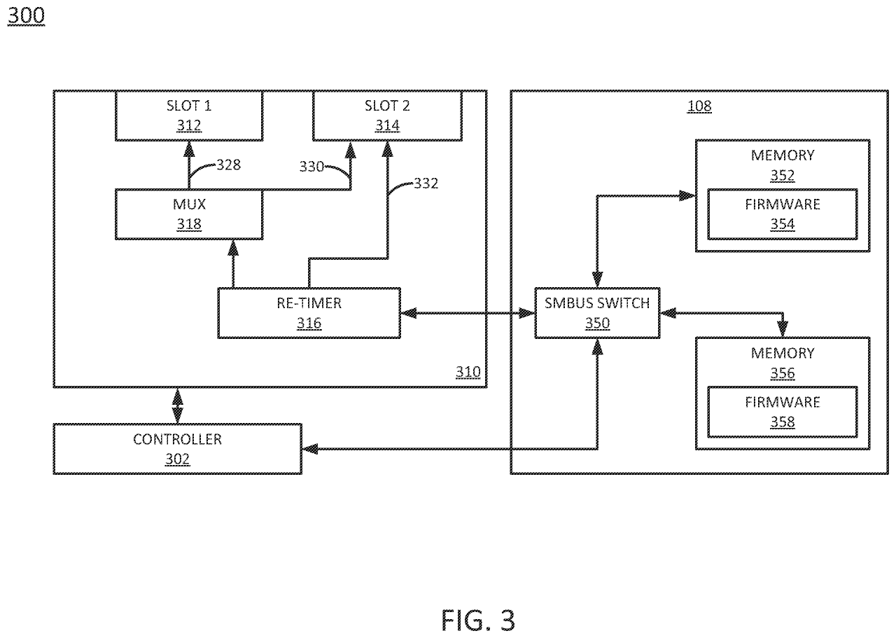

In an example, the configuration change module 108 may be implemented without hardware or circuit changes by modifying operation of the basic input/output system (BIOS) of the computing device 100, as illustrated in FIG. 2 and described below. In another example, the configuration change module 108 may be implemented with a hardware change, as illustrated in FIG. 3 and described below.

FIG. 2 illustrates an example computing device 200. The computing device 200 may be similar to the computing device 100. For example, the computing device 200 may include a controller 202, a memory 204, an expansion interface 210, and the configuration change module 108.

In an example, the expansion interface 210 may include a re-timer 216, a multiplexer (mux) 218, a first slot 212 and a second slot 214. In an example, the expansion interface 210 may include channels 228, 230, and 232. Each of the channels 228, 230, and 232 may include 8 data lanes.

In an example, the multiplexer 218 may be controlled based on a present pin of an AIC that is connected to the first slot 212 or the second slot 214. The multiplexer 218 may be active low. When an AIC is connected to the first slot 212 or the second slot 214, the AIC may send a low signal to the multiplexer 218. If a low signal is received from the second slot 214 and not the first slot 212, then the multiplexer 218 may send data over channels 230 to the second slot 214. If a low signal is received from the first slot 212 and the second slot 214, the multiplexer 218 may send data over the channel 228 to the first slot 212.

The re-timer 216 may send data signals that coordinate with the configuration of the multiplexer 218. For example, the re-timer 216 may direct data over the channel 228 to the first slot 212 in accordance with a 2×8 configuration or over the channel 230 to the second slot 214 as part of a 1×16 configuration based on how the multiplexer 218 is set from the low signals received from the first slot 212 and/or the second slot 214. The 2×8 configuration may be deployed when two AICs are connected (e.g., a first AIC connected to the first slot 212 and a second AIC connected to the second slot 214). The 1×16 configuration may be deployed when a single AIC is connected (e.g., an AIC connected to the second slot 214 while the first slot 212 is empty).

In an example, the configuration change module 108 may change the configuration of the first slot 212 and the second slot 214 when a change in the number of AICs is detected, as described above. FIG. 2 illustrates an example of the configuration change module 108 that is implemented without hardware or circuit changes by modifying operation of a BIOS 220. In an example, the configuration module 108 may include the BIOS 220, a host controller 222 (e.g., a platform controller hub (PCH)) and a system management bus (SMBus) 250.

As used herein, a BIOS refers to hardware or hardware and instructions to initialize, control, or operate a computing device prior to execution of an operating system (OS) of the computing device. Instructions included within a BIOS may be software, firmware, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of the computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the Unified Extensible Firmware Interface (UEFI) specification or another specification or standard for initializing, controlling, or operating a computing device.

In an example, the BIOS 220 may be modified to use the general purpose input/output (GPIO) of the host controller 222 to transmit signals to the expansion interface 210 to change the configuration of the first slot 112 and the second slot 114 by changing the way the re-timer 216 operates.

For example, when a change in the number of AICs connected to the first slot 212 and 214 is detected, the BIOS 220 may initiate a configuration change process when the computing device 200 is powered back on. For example, the computing device 200 may be initially deployed with a single add-in card connected to the second slot 214. The firmware 206 may be firmware to configure the slots 212 and 214 to operate in a 1×16 configuration. The re-timer 216 may be set to operate the slots 212 and 214 in the 1×16 configuration. For example, the multiplexer 218 may send data over the 8 data lanes of the channel 230 to the second slot 214.

A user may power down the computing device 200 and connect a second AIC to the first slot 212. When the computing device 200 is powered on, the BIOS 220 may detect the change in the number of AICs connected to the expansion interface 210. In other words, the BIOS 220 may detect that an AIC was added to the first slot 212. Thus, the configuration of the slots 212 and 214 should be changed from a 1×16 configuration to a 2×8 configuration. In addition, the multiplexer 218 may receive a low signal from the present pin of the AIC connected to the first slot 212 to configure the multiplexer 218 to send data over channel 228 instead of channel 230.

The BIOS 220 may cause the host controller 222 to send a signal 229 via the SMBus 250 to change a register of the re-timer 216. Changing the register of the re-timer 216 may cause the re-timer 216 to change operation from a 1×16 configuration to a 2×8 configuration. The BIOS 220 may also cause the host controller 222 send a reset signal 226 to the re-timer to restart or resynchronize the timing or clock signal of the re-timer 216 in accordance with the new configuration. The reset signal 226 may be a voltage high or voltage low signal. For example, the reset signal 226 may be a global reset signal (PERST) signal.

Notably, the configuration of the slots 212 and 214 and the operation of the re-timer 216 may be changed without having to update or change the firmware 206. Rather, the initial firmware 206 is still stored in the memory 204. However, the operation of the BIOS 220 may temporarily override the configuration of the initial firmware 206 that was loaded.

At a later time, if one of the AICs is removed, the BIOS 220 can detect the change and then change the configuration of the slots 212 and 214 back to the initial 1×16 configuration from the 2×8 configuration. For example, the change can be detected by the BIOS 220 when the computing device 200 is powered on. The BIOS 220 may cause the host controller to send the signal 229 over the SMBus 250 to change the register of the re-timer 216 back to the 1×16 configuration. The BIOS 220 may also cause the host controller to send the reset signal 226 to restart or resynchronize the timing or clock signal of the re-timer 216 in accordance with the new configuration.

FIG. 3 illustrates an example computing device 300. The computing device 300 may be similar to the computing device 100. For example, the computing device 300 may include a controller 302, an expansion interface 310, and the configuration change module 108.

In an example, the expansion interface 310 may include a re-timer 316, a multiplexer (mux) 318, a first slot 312 and a second slot 314. In an example, the expansion interface 310 may include channels 328, 330, and 332. Each of the channels 328, 330, and 332 may include 8 data lanes. Similar to the multiplexer 218, the multiplexer 318 may be controlled based on whether a low signal is received from a present pin of an AIC connected to the first slot 312 and/or the second slot 314.

The re-timer 316 may send data signals that coordinate with the configuration of the multiplexer 318. For example, the re-timer 316 may direct data over the channel 328 to the first slot 312 in accordance with a 2×8 configuration or over the channel 330 to the second slot 314 as part of a 1×16 configuration based on how the multiplexer 318 is set from the low signals received from the first slot 312 and/or the second slot 314. The 2×8 configuration may be deployed when two AIC are connected (e.g., a first AIC connected to the first slot 312 and a second AIC connected to the second slot 314). The 1×16 configuration may be deployed when a single AIC is connected (e.g., an AIC connected to the second slot 314 while the first slot 312 is empty).

In an example, the configuration change module 108 may change the configuration of the first slot 312 and the second slot 314 when a change in the number of AICs is detected, as described above. FIG. 3 illustrates an example of the configuration change module 108 that is implemented with hardware changes.

In an example, the configuration module 108 may include an SMBus switch 350, a first memory 352, and a second memory 356. The SMBus switch 350 may be communicatively coupled to the first memory 352 and the second memory 356. The SMBus switch 350 may control whether the re-timer 316 accesses firmware stored in the first memory 352 or the second memory 356.

In an example, the first memory 352 and the second memory 356 may be separate EEPROM memory modules. The first memory 352 may store a firmware 354 and the second memory 356 may store a firmware 358. The firmware 354 and the firmware 358 may be different firmware to implement different configurations of the slots 312 and 314 and different operation of the re-timer 316. For example, the firmware 354 may be for a 1×16 configuration and the firmware 358 may be for a 2×8 configuration.

In an example, when a change in the number of AICs connected to the slots 312 and/or 314 of the expansion interface 310 is detected, the controller 302 may cause the SMBus switch 350 to switch to the memory 352 to load the firmware 354 or to the memory 356 to load the firmware 358. For example, the computing device 300 may be deployed with two AICs. The firmware 358 may be associated with a 2×8 configuration. Thus, the firmware 358 may be initially loaded to configure the slots 312 and 314 in the 2×8 configuration.

At a later time, a user may power down the computing device 300 and remove the AIC from the slot 312. As a result, the number of AICs may change from two to one. Thus, the operation of the slots 312 and 314 should be changed from a 2×8 configuration to a 1×16 configuration.

The computing device 300 may be powered on and the change in the number of AICs can be detected. For example, the BIOS of the computing device 300 may detect the change in the number of AICs as part of a boot sequence. The removal of the AIC from the first slot 312 may cause the multiplexer 318 to no longer receive the low signal from the present pin of the AIC that was connected to the first slot 312. As a result, the multiplexer 318 may send data over the channel 330 to the second slot 314 instead of over the channel 328 to the first slot 312.

The change in the number of AICs may be reported to the controller 302. The controller 302 may signal the SMBus switch 350 to switch from the second memory 356 to the first memory 352. The controller 302 may then load the firmware 354 associated with the 1×16 configuration. For example, the multiplexer 318 may transmit data over the channel 330 to the second slot 314 instead of over channel 328 to the first slot 312. In addition, the re-timer 316 may operate the second slot 314 in the 1×16 configuration.

Notably, the configuration of the slots 312 and 314 and the operation of the re-timer 216 may be changed without having to update or change the firmware 354 or 358. Rather, the firmware for the various possible configurations of the slots 312 and 314 may be stored in separate memory modules and selected via the SMBus switch 350 based on the detected number of AICs connected to the expansion interface 310 and the associated configuration.

Thus, the present disclosure may change a configuration of the slots on a PCIe interface without updating or downloading different firmware. Rather, the configuration of the slots and the operation of the re-timer may be changed to the desired configuration when a change in the number of AICs is detected via the configuration change module 108 of the present disclosure. The configuration change module 108 may be implemented without hardware or circuit changes (e.g., as shown in FIG. 2) or with hardware changes (e.g., as shown in FIG. 3).

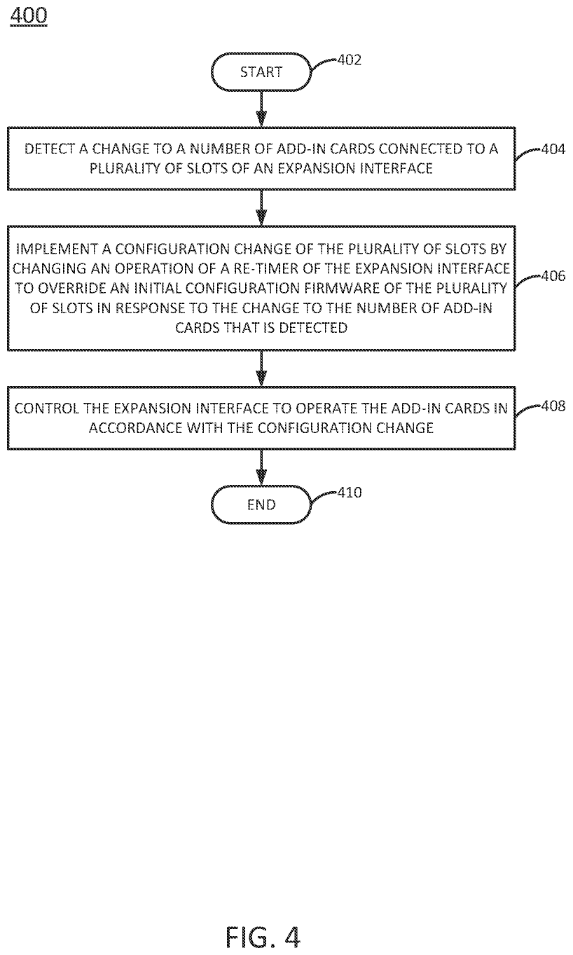

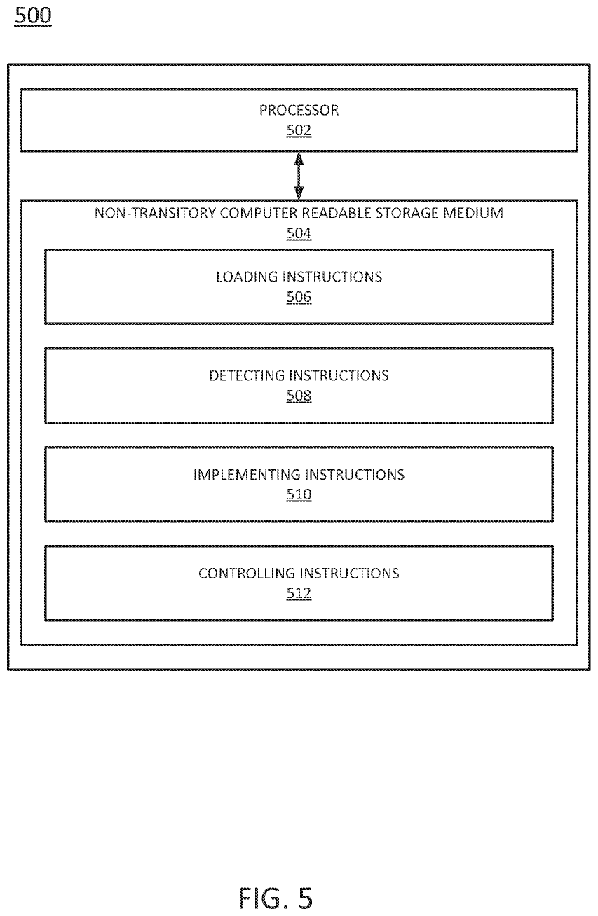

FIG. 4 illustrates a flow diagram of an example method 400 to change a configuration of a plurality of slots of an expansion interface of the present disclosure. In an example, the method 400 may be performed by the computing device 100 illustrated in FIG. 1, the computing device 200 illustrated in FIG. 2, the computing device 300 illustrated in FIG. 3, or the apparatus 500 illustrated in FIG. 5, and described below.

At block 402, the method 400 begins. At block 404, the method 400 detects a change to a number of add-in cards connected to a plurality of slots of an expansion interface. For example, the expansion interface may be a PCIe interface. The number of AICs connected to the slots of the PCIe interface may be changed from two cards to one card or one card to two cards.

At block 406, the method 400 implements a configuration change of the plurality of slots by changing an operation of a re-timer of the expansion interface to override an initial configuration firmware of the plurality of slots in response to the change to the number of add-in cards that is detected. For example, changing from two cards to one card may change the configuration from a 2×8 configuration to a 1×16 configuration. Changing from one card to two cards may change the configuration from a 1×16 configuration to a 2×8 configuration.

In an example, the computing device may be deployed with an initial configuration associated with a firmware that is saved to memory and loaded when the computing device is initially powered on. However, a user may change the number of AICs that are connected to the expansion interface. When the computing device detects the change to the number of connected add-in cards, the computing device may change the configuration in accordance with the detected number of AICs connected to the expansion interface.

In an example, the change in the number of AICs may be detected by a BIOS of the computing device. The configuration change may be implemented by the BIOS. For example, the BIOS can cause a host controller to send a signal over a system management bus (SMBus) and a change in voltage of a reset signal of the expansion interface to change a register of the re-timer to operate in accordance with the configuration change.

In another example, the configuration change may be implemented via hardware. For example, the computing device may include a first memory that stores a first firmware associated with a first configuration and a second memory that stores a second firmware associated with a second configuration. In an example, the first firmware may load a 1×16 configuration and the second firmware may load a 2×16 configuration. An SMBus switch may be coupled to the first memory and the second memory and may control which memory is accessed based on the desired configuration of the expansion interface.

For example, a controller or processor may determine whether a firmware for the configuration change is stored in a first memory or a second memory. The controller may control the SMBus switch to connect to the first memory or to the second memory that stores the firmware for the configuration change. The controller may load the firmware for the configuration change from the first memory or from the second memory that is connected by the SMBus switch

At block 408, the method 400 controls the expansion interface to operate the add-in cards in accordance with the configuration change. For example, if the number of AICs changed from one card to two cards, the configuration change may be from a 1×16 configuration to a 2×8 configuration, and the expansion interface may be controlled to operate in the 2×8 configuration. Alternatively, if the number of AICs changed from two cards to one card, the configuration change may be from a 2×8 configuration to a 1×16 configuration, and the expansion interface may be controlled to operate in the 1×16 configuration. At block 410, the method 400 ends.

FIG. 5 illustrates an example of an apparatus 500. In an example, the apparatus 500 may be the apparatus 100, 200, or 300. In an example, the apparatus 500 may include a processor 502 and a non-transitory computer readable storage medium 504. The non-transitory computer readable storage medium 504 may include instructions 506, 508, 510, and 512 that, when executed by the processor 502, cause the processor 502 to perform various functions.

In an example, the instructions 506 may include loading instructions. For example, the instructions 506 may load an initial firmware to operate a re-timer in a 1×16 configuration of an expansion interface for a first add-in card connected to a first slot of the expansion interface.

The instructions 508 may include detecting instructions. For example, the instructions 508 may detect a second add-in card connected to a second slot of the expansion interface.

The instructions 510 may include implementing instructions. For example, the instructions 510 may implement a configuration change via a configuration change module to change operation of the re-timer to a 2×8 configuration. For example, the configuration change may be implemented by transmitting a signal over the SMBus and a voltage change to a reset signal of the expansion interface to change a register of the re-timer from the 1×16 configuration to the 2×8 configuration. In another example, the configuration change may be implemented by controlling an SMBus switch to disconnect from a first memory that stores a 1×16 configuration firmware and to connect to a second memory that stores a 2×8 configuration firmware and by loading the 2×8 configuration firmware from the second memory when the computing device is powered on.

The instructions 512 may include controlling instructions. For example, the instructions 512 may control the re-timer to repeat data signals in the 2×8 configuration for the first slot connected to the first add-in card and the second slot connected to the second add-in card.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A computing device, comprising:
an expansion interface comprising:
a plurality of slots, each slot of the plurality of slots to connect to a respective add-in card; and
a re-timer to control an operation of the plurality of slots;
a memory to store a firmware that sets a configuration of the plurality of slots, wherein the re-timer is to control the operation of the plurality of slots in accordance with the configuration set by the firmware;
a controller to control operation of the expansion interface; and
a configuration change module to change the configuration of the plurality of slots when a change in a number of connected add-in cards is detected.

2. The computing device of claim 1, wherein the expansion interface comprises a peripheral component interconnect express (PCIe) interface.

3. The computing device of claim 1, wherein the configuration change module comprises:
a host controller; and
a system manage bus (SMBus) communicatively coupled to the host controller, wherein the host controller is to change a register of the re-timer to implement a configuration change of the plurality of slots via a signal transmitted over the SMBus and a change in voltage of a peripheral component interconnect express (PCIe) reset signal.

4. The computing device of claim 3, wherein the configuration change comprises a change from a 1×16 configuration of the plurality of slots to a 2×8 configuration of the plurality of slots or a change from a 2×8 configuration of the plurality of slots to a 1×16 configuration of the plurality of slots.

5. The computing device of claim 3, further comprising:
a basic input/output system (BIOS) to cause the host controller to transmit the signal over the SMBus to implement the configuration change in response to the number of connected add-in cards being detected.

6. The computing device of claim 1, wherein the configuration change module comprises:
a first memory to store a first configuration firmware;
a second memory to store a second configuration firmware; and
a system management bus (SMBus) switch to select the first memory or the second memory in response to the number of connected add-in cards being detected.

7. The computing device of claim 6, wherein each of the first memory and the second memory comprises electrically erasable programmable read-only memory (EEPROM).

8. The computing device of claim 6, wherein the first configuration firmware sets the plurality of slots to a 1×16 configuration.

9. The computing device of claim 6, wherein the second configuration firmware sets the plurality of slots to a 2×8 configuration.

10. The computing device of claim 1, wherein the expansion interface further comprises:
a multiplexer to direct a subset of data lanes of the expansion interface to a first slot of the plurality of slots or to a second slot of the plurality of slots based on the configuration that is set.

11. A method, comprising:
detecting, by a processor, a change to a number of add-in cards connected to a plurality of slots of an expansion interface;
implementing, by the processor, a configuration change of the plurality of slots by changing an operation of a re-timer of the expansion interface to override an initial configuration firmware of the plurality of slots in response to the change to the number of add-in cards that is detected; and
controlling, by the processor, the expansion interface to operate the add-in cards in accordance with the configuration change.

12. The method of claim 11, wherein the number of add-in cards is changed from one add-in card to two add-in cards, and the configuration change is to change the operation of the re-timer from a 1×16 configuration to a 2×8 configuration.

13. The method of claim 11, wherein the number of add-in cards is changed from two add-in cards to one add-in card, and the configuration change is to change the operation of the re-timer from a 2×8 configuration to a 1×16 configuration.

14. The method of claim 11, wherein the change is detected by a basic input/output system (BIOS) of a computing device of the processor during a power on cycle, and the implementing the configuration change comprises:
causing, by the processor, a host controller to send a signal over a system management bus (SMBus) and to send a change in voltage of a reset signal of the expansion interface to change a register of the re-timer to operate in accordance with the configuration change.

15. The method of claim 11, wherein the implementing the configuration change comprises:
determining, by the processor, whether a firmware for the configuration change is stored in a first memory or a second memory;
controlling, by the processor, a system management bus (SMBus) switch to connect to the first memory or to the second memory that stores the firmware for the configuration change; and
loading, by the processor, the firmware for the configuration change from the first memory or from the second memory that is connected by the SMBus switch.

16. The method of claim 15, wherein the first memory stores a 1×16 configuration firmware and the second memory stores a 2×8 configuration firmware.

17. A non-transitory computer readable storage medium encoded with instructions which, when executed, cause a processor of a computing device to:
load an initial firmware to operate a re-timer in a 1×16 configuration of an expansion interface for a first add-in card connected to a first slot of the expansion interface;
detect a second add-in card connected to a second slot of the expansion interface;
implement a configuration change via a configuration change module to change an operation of the re-timer to a 2×8 configuration; and
control the re-timer to repeat data signals in the 2×8 configuration for the first slot connected to the first add-in card and for the second slot connected to the second add-in card.

18. The non-transitory computer readable storage medium of claim 17, wherein the instructions which cause the processor to implement the configuration change via the configuration change module further cause the processor to:
transmit a signal over a system management bus (SMBus) and to transmit a voltage change to a reset signal of the expansion interface to change a register of the re-timer from the 1×16 configuration to the 2×8 configuration.

19. The non-transitory computer readable storage medium of claim 17, wherein the instructions which cause the processor to implement the configuration change via the configuration change module further cause the processor to:
control a system management bus (SMBus) switch to disconnect from a first memory that stores a 1×16 configuration firmware and to connect to a second memory that stores a 2×8 configuration firmware; and
load the 2×8 configuration firmware from the second memory when the computing device is powered on.

20. The non-transitory computer readable storage medium of claim 17, wherein the instructions, when executed, further cause the processor to:
switch a multiplexer to divert 8 data lanes from the first slot to a second slot for the 2×8 configuration.
